(19) United States
(12) Patent Application Publication
(10) Pub. No.: US 2017/0338537 A1
(43) Pub. Date: Nov. 23, 2017

(54) METAL-AIR SECONDARY BATTERY

(71) Applicant: HITACHI ZOSEN CORPORATION, Osaka (JP)

(72) Inventors: Sousuke NISHIURA, Osaka (JP); Kazuya KAMEYAMA, Osaka (JP); Takehiro SHIMIZU, Osaka (JP); Masanobu AIZAWA, Osaka (JP)

(21) Appl. No.: 15/595,027

(22) Filed: May 15, 2017

(30) Foreign Application Priority Data
May 17, 2016 (JP) 2016-098923

(51) Int. Cl. H01M 12/08; H01M 4/38; H01M 4/90

(52) U.S. Cl. CPC H01M 12/08; H01M 4/9016; H01M 4/38; H01M 2300/0014

(57) ABSTRACT

A metal-air battery has a positive electrode including a positive electrode conductive layer, a first catalyst layer, and a second catalyst layer. The positive electrode conductive layer is a porous layer made of conductive ceramic and has pores filled with an electrolyte solution. The first catalyst layer is a porous layer formed on a surface of the positive electrode conductive layer on the side opposite to the negative electrode, is made of conductive ceramic having a smaller average particle diameter than that of the positive electrode conductive layer, and has pores filled with the electrolyte solution. This improves charge performance. The second catalyst layer is a porous layer formed on a surface of the first catalyst layer on the side opposite to the negative electrode and is made of conductive ceramic having a larger average particle diameter than that of the first catalyst layer. This improves discharge performance.

### TECHNICAL FIELD

The present invention relates to a metal-air secondary battery.

### BACKGROUND ART

There are conventionally known metal-air secondary batteries that use a metal as an active material for the negative electrode and oxygen from the air as an active material for the positive electrode. Japanese Patent Application Laid-Open No. 2005-190833 (Document 1) discloses an electrode that can be used for the positive electrodes (air electrodes) of metal-air secondary batteries. This electrode uses a catalyst in which multiple types of perovskite type oxides are uniformly dispersed and supported on carbon powder. Document 1 also proposes a combined use of a catalyst that is superior in oxygen generation properties and a catalyst that is superior in oxygen reduction properties.

Japanese Patent Application Laid-Open No. 2004-265739 discloses a fuel battery cell that includes an oxygen electrode layer having a two-layer structure. This oxygen electrode layer includes a reaction layer and a gas supply layer, the reaction layer being made of fine particles of conductive ceramic having an average particle diameter of 2 μm or less, and the gas supply layer being made of coarse particles of conductive ceramic having an average particle diameter of 10 to 100 μm.

At the positive electrode of a metal-air secondary battery, oxygen reduction reactions occur during discharge at interfaces between the three phases of solid (catalyst), liquid (electrolyte solution), and gas (air), and oxygen generation reactions occur during charge at interfaces between the two phases of solid (catalyst) and liquid (electrolyte solution). Thus, merely dispersing multiple types of catalysts as in Document 1 sets certain limits to improvements in battery performance.

### SUMMARY OF INVENTION

The present invention is intended for a metal-air secondary battery, and it is an object of the present invention to improve the battery performance of the metal-air secondary battery.

The metal-air secondary battery according to the present invention includes a positive electrode, a negative electrode opposing the positive electrode, and an electrolyte layer that is disposed between the positive electrode and the negative electrode and containing an electrolyte solution. The positive electrode includes a positive electrode conductive layer, a first catalyst layer, and a second catalyst layer. The positive electrode conductive layer is a porous layer made of conductive ceramic and has pores filled with the electrolyte solution. The first catalyst layer is a porous layer formed on a surface of the positive electrode conductive layer on a side opposite to the negative electrode, is made of conductive ceramic having a smaller average particle diameter than the conductive ceramic of the positive electrode conductive layer, and has pores filled with the electrolyte solution. The second catalyst layer is a porous layer formed on a surface of the first catalyst layer on the side opposite to the negative electrode and is made of conductive ceramic having a larger average particle diameter than the conductive ceramic of the first catalyst layer.

With the present invention, battery performance can be improved.

In a preferred embodiment of the present invention, the second catalyst layer holds particles of a liquid repellent material in a portion that is in the vicinity of a surface of the second catalyst layer on the side opposite to the negative electrode.

In another preferred embodiment of the present invention, the average particle diameter of the conductive ceramic of the first catalyst layer is larger than or equal to 0.1 micrometers and smaller than or equal to 2 micrometers.

In yet another preferred embodiment of the present invention, the average particle diameter of the conductive ceramic of the second catalyst layer is larger than or equal to 1 micrometer and smaller than or equal to 10 micrometers.

According to an aspect of the present invention, the second catalyst layer has a thickness that is greater than or equal to 0.4 times a thickness of the first catalyst layer and less than or equal to 2.3 times the thickness of the first catalyst layer.

According to another aspect of the present invention, the conductive ceramic of the first catalyst layer and the conductive ceramic of the second catalyst layer are different materials.

In this case, preferably, the conductive ceramic of the first catalyst layer is superior in oxygen generation reaction to the conductive ceramic of the second catalyst layer, and the conductive ceramic of the second catalyst layer is superior in oxygen reduction reaction to the conductive ceramic of the first catalyst layer.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 illustrates a configuration of a metal-air battery;

FIG. 2 illustrates another example of the metal-air battery; and

FIG. 3 illustrates the relationship among the material for each catalyst layer, the particle diameter, and charge and discharge performance.

### DESCRIPTION OF EMBODIMENTS

FIG. 1 illustrates a configuration of a metal-air battery 1 according to an embodiment of the present invention. The metal-air battery 1 in FIG. 1 is a metal-air secondary battery using zinc ions, i.e., a zinc-air secondary battery. The metal-air battery may use other metal ions. The metal-air battery 1 has a main body 11 having a generally columnar shape centered on a central axis J1, and FIG. 1 illustrates a cross section of the main body 11 (excluding a negative electrode 3, which will be described later) in a plane perpendicular to the central axis J1. The metal-air battery 1 includes a positive electrode 2, the negative electrode 3, and an electrolyte layer 4.

The negative electrode 3 (also referred to as a “metal electrode”) is a coiled member centered on the central axis J1. The negative electrode 3 according to the present embodiment is shaped by winding a linear member having a generally circular cross-sectional shape in a spiral about the central axis J1. The negative electrode 3 includes a coiled base member made of a conductive material, and a deposited metal layer formed on a surface of the base member. An end of the negative electrode 3 in the direction of the central axis J1 is connected to a negative electrode current collecting terminal (not shown).

Examples of the material for the aforementioned base member include metals such as copper (Cu), nickel (Ni), silver (Ag), gold (Au), iron (Fe), aluminum (Al), and magnesium (Mg) and alloys containing any of these metals. In the present embodiment, the base member is made of copper. From the viewpoint of increasing the conductivity of the base member serving also as a current collector, the base member preferably contains copper or a copper alloy. When the main body of the base member is made of copper, it is preferable for a surface of the main body to have a protective film of another metal such as nickel. In this case, a surface of the protective film makes the surface of the base member. For example, the protective film has a thickness of 1 to 20 micrometers (μm) and is formed by plating. The deposited metal layer is formed by electrodeposition of zinc (Zn). Alternatively, the deposited metal layer may be formed by electrodeposition of an alloy containing zinc. Depending on the design of the metal-air battery 1, the negative electrode 3 may have a tubular or rod-like shape.

A cylindrical separator 41 is provided on the periphery of the negative electrode 3, and the cylindrical positive electrode 2 (also referred to as an “air electrode”) is provided on the periphery of the separator 41. The negative electrode 3 and the inner side surface of the positive electrode 2 are opposed via the separator 41. The negative electrode 3, the separator 41, and the positive electrode 2 are provided concentrically about the central axis J1, and the distance between the outer edge of the negative electrode 3 and the positive electrode 2, when viewed in the direction of the central axis J1, is constant along the entire circumference in a circumferential direction about the central axis J1. That is, the interval between equipotential surfaces of the negative electrode 3 and the positive electrode 2 is constant along the entire circumference. Since there is no unevenness of the equipotential surfaces, the current distribution in the circumferential direction is constant during charge and discharge. Note that the positive electrode 2 may have, for example, a tubular regular polygonal shape having six or more vertices as long as the current distribution is approximately uniform along the entire circumference.

The positive electrode 2 includes a positive electrode conductive layer 21, a first catalyst layer 221, and a second catalyst layer 222. The positive electrode conductive layer 21 is a cylindrical porous layer and also plays a role of a supporter in the metal-air battery 1 in FIG. 1. The first catalyst layer 221 is a porous layer formed on the outer side surface of the positive electrode conductive layer 21 on the side opposite to the negative electrode 3. The second catalyst layer 222 is a porous layer formed on the outer side surface of the first catalyst layer 221 on the side opposite to the negative electrode 3. The positive electrode 2 has a two-layer structure of the catalyst layers, and has a three-layer structure of the conductive layer and the catalyst layers. Preferably, the first and second catalyst layers 221 and 222 may be formed on the entire periphery of the positive electrode conductive layer 21. The first and second catalyst layers 221 and 222 have thicknesses (wall thicknesses) sufficiently smaller than the thickness of the positive electrode conductive layer 21 and are supported by the positive electrode conductive layer 21. For example, the positive electrode conductive layer 21 may have a thickness of 2 millimeters (mm), and the first and second catalyst layers 221 and 222 may have thicknesses of 50 to 100 μm.

The positive electrode conductive layer 21 is a sintered compact of conductive ceramic and formed by, for example, extrusion molding and firing of a material containing the conductive ceramic. Preferable examples of the conductive ceramic include perovskite type oxides and spinel type oxides, both having conductivity. In the present embodiment, the positive electrode conductive layer 21 is formed of a perovskite type oxide (e.g., LaSrMnO₃ (LSM), LaSrMnFeO₃ (LSMF), or LaSrCoFeO₃ (LSCF)). The perovskite type oxide used for the positive electrode conductive layer 21 preferably contains at least one of cobalt (Co), manganese (Mn), and iron (Fe). Particles of the conductive ceramic of the positive electrode conductive layer 21 have an average particle diameter of, for example, several tens of μm. The positive electrode conductive layer 21 having a large average particle diameter can ensure high electrolyte permeability, high conductivity, and high strength. The porosity of the positive electrode conductive layer 21 is preferably 30% or above. If the porosity is less than 30%, electrolyte permeability decreases. The porosity of the positive electrode conductive layer 21 is also preferably 80% or less. If the porosity is above 80%, the strength of the positive electrode conductive layer 21 serving as a supporter decreases. From the viewpoint of preventing degradation of the positive electrode conductive layer 21 due to oxidation during charge, it is preferable for the positive electrode conductive layer 21 to not contain conductive carbon. Depending on the shape of the positive electrode conductive layer 21, other methods such as doctor blading, rolling, or pressing may be used.

The first and second catalyst layers 221 and 222 are sintered compacts formed by firing conductive ceramic such as perovskite type oxides (e.g., LSM, LSCF, or LSMF). The first catalyst layer 221 is formed of conductive ceramic having a smaller average particle diameter than the conductive ceramic of the positive electrode conductive layer 21. The second catalyst layer 222 is formed of conductive ceramic having a larger average particle diameter than the conductive ceramic of the first catalyst layer 221. The average particle diameter of the second catalyst layer 222 may, for example, be smaller than the average particle diameter of the positive electrode conductive layer 21. In the metal-air battery 1 in FIG. 1, the conductive ceramic of the first catalyst layer 221 and the conductive ceramic of the second catalyst layer 222 are different materials.

In the process of forming the first and second catalyst layers 221 and 222, slurry that contains, for example, conductive ceramic powder for catalyst layers, an organic binder, and an organic solvent is prepared and deposited on the positive electrode conductive layer 21 by a film deposition method such as a slurry coating method. In the metal-air battery 1 in FIG. 1, slurry for the first catalyst layer 221 is deposited on the outer side surface of the positive electrode conductive layer 21, and then slurry for the second catalyst layer 222 is deposited thereon. These slurry films are fired together with the positive electrode conductive layer 21 to form the first and second catalyst layers 221 and 222. Examples of the slurry coating method include casting, dipping, spraying, and printing. The thickness of each layer is adjusted in consideration of firing shrinkage during firing within a range of values at which properties relating to battery performance such as gas permeability and electrolyte permeability can be ensured.

Before firing the slurry films, organic components in the films may be decomposed and removed by heat treatment at a temperature of 100 to 800° C. The firing is preferably conducted at a temperature of 900 to 1500° C. with use of any condition as long as the slurry films are sintered sufficiently and predetermined properties such as gas permeability, electrolyte permeability, and battery performance can be ensured. Alternatively, a plurality of layers may be co-fired. The co-firing will help improve the adhesive strength between these layers. The co-firing will also help reduce the lead time of the firing process, as compared with the case where each layer is fired individually.

An interconnector 24 is provided on part of the outer side surface of the second catalyst layer 222. The interconnector 24 is made of ceramic having alkali resistance and has a thickness of, for example, approximately 30 to 300 μm. The interconnector 24 is connected to a positive electrode current collecting terminal (not shown). On the area of the outer side surface of the second catalyst layer 222 that is not covered with the interconnector 24, a porous layer made of a predetermined liquid repellent material (e.g., tetrafluoroethylene-hexafluoropropylene copolymer (FEP) or polytetrafluoroethylene (PTFE)) is formed as a liquid repellent layer 29. The liquid repellent layer 29 has high gas permeability and high liquid impermeability. In actuality, the liquid repellent layer 29 is formed by holding (supporting) particles of a liquid repellent material in a portion of the second catalyst layer 222 in the vicinity of the outer side surface thereof on the side opposite to the negative electrode 3. That is, the liquid repellent layer 29 is part of the second catalyst layer 222.

In the process of forming the liquid repellent layer 29, slurry that contains a liquid repellent material is applied to the outer side surface of the second catalyst layer 222 by, for example, a slurry coating method. At this time, a portion of the outer side surface corresponding to the interconnector 24 is preferably masked. Also, the depth of impregnation of the slurry in the depth direction of the second catalyst layer 222 is adjusted by adding the required amount of a thickener to the slurry to adjust the viscosity of the slurry. This adjustment allows an interface of (an air and) an electrolyte solution 40, which will be described later, to be formed inside the second catalyst layer 222 while preventing the surfaces of particles in the pores of the second catalyst layer 222 from being completely covered with the liquid repellent material.

The separator 41 described previously is a porous film formed on the inner side surface of the positive electrode conductive layer 21 on the negative electrode 3 side, and formed along the entire circumference on the inner side surface. For example, the separator 41 may be a sintered compact of ceramic powder having high mechanical strength and high insulating properties, such as silica (SiO₂), alumina (Al₂O₃), zirconia (ZrO₂), titania (TiO₂), hafnia (HfO₂), or ceria (CeO₂), and have high alkali resistance. In the production of the separator 41, slurry that contains, for example, the aforementioned ceramic powder and a binder is deposited on the inner side surface of the positive electrode conductive layer 21 by, for example, a slurry coating method and dried, and the binder contained in the slurry is removed by firing at a high temperature. The removal of the binder prevents the separator 41 from having a short lifetime due to degradation of the binder. The separator 41 is preferably configured of only ceramic. Alternatively, the separator 41 may be a mixture or laminated body of the aforementioned kinds of ceramic.

The average pore diameter of the separator 41 is preferably larger than or equal to 0.01 μm and smaller than or equal to 2 μm. With this average pore diameter, it is possible to prevent deposited metal (e.g., dendrites) on the negative electrode 3 from passing through the separator 41. The average pore diameter of the separator 41 is also preferably smaller than the average pore diameter of the positive electrode conductive layer 21. For example, the cylindrical separator 41 has a thickness (wall thickness) of 25 to 50 μm which is sufficiently smaller than the thickness of the positive electrode conductive layer 21. When the separator 41 is made of a material such as alumina or zirconia and the positive electrode conductive layer 21 is made of an oxide such as LSC (LaSrCoO₃) or LSCF, a case is conceivable in which a reaction phase is formed between the separator 41 and the positive electrode conductive layer 21 and causes problems such as a reduction in the conductivity of the positive electrode conductive layer 21 and clogging of the pores. In this case, it is preferable to form an anti-reaction layer that contains ceria, for example, between the separator 41 and the positive electrode conductive layer 21. On the other hand, when there is a large difference in the coefficient of linear expansion between the separator 41 and the positive electrode conductive layer 21, cracks may occur during firing. In this case, it is preferable to form a layer for reducing the difference in the coefficient of linear expansion between the separator 41 and the positive electrode conductive layer 21. If the generation of dendrites or other defects causes little problems in the metal-air battery 1, the separator 41 may be omitted.

The space on the inner side (central axis J1 side) of the tubular positive electrode 2 is filled with the water-based electrolyte solution 40. The negative electrode 3 is immersed almost in its entirety in the electrolyte solution 40. The pores of the separator 41 are filled with the electrolyte solution 40. Thus, the electrolyte solution 40 exists between and in contact with the positive electrode 2 and the negative electrode 3. In the following description, the space between the negative electrode 3 and the positive electrode 2, when viewed in the direction along the central axis J1, is referred to as the “electrolyte layer 4.” That is, the electrolyte layer 4 is disposed between the negative electrode 3 and the positive electrode 2. In the present embodiment, the electrolyte layer 4 includes the separator 41 and the electrolyte solution 40 held by the separator 41.

The electrolyte solution 40 is an aqueous alkaline solution that preferably contains an aqueous potassium hydroxide (caustic potash, KOH) solution or an aqueous sodium hydroxide (caustic soda, NaOH) solution. The electrolyte solution 40 also contains zinc ions or ions containing zinc. That is, zinc ions contained in the electrolyte solution 40 may be in various forms and, for example, may exist as tetrahydroxy zinc ions. The metal-air battery 1 may also use other types of electrolyte solution.

The pores of the whole positive electrode conductive layer 21 and the pores of the whole first catalyst layer 221 are also filled up with the electrolyte solution 40. As described previously, the liquid repellent layer 29, which is a portion of the second catalyst layer 222 in the vicinity of the outer side surface thereof, is made of a liquid repellent material that has liquid repellent properties to the electrolyte solution 40. Thus, the interface between the air and the electrolyte solution 40 is formed in the liquid repellent layer 29. In other words, the above interface is formed inside the second catalyst layer 222 while the pores in the portion of the second catalyst layer 222 in the vicinity of the inner side surface thereof are also filled with the electrolyte solution 40.

The opposite end surfaces of the negative electrode 3, the electrolyte layer 4, and the positive electrode 2 in the direction of the central axis J1 are fixed to disc-like closure members. Each closure member has a through hole in the center. In the metal-air battery 1, the liquid repellent layer 29 and the closure members prevent the electrolyte solution 40 in the main body 11 from leaking out from portions other than the aforementioned through holes to the outside. The electrolyte solution can also be circulated between the main body 11 and a reservoir tank (not shown) by using the through holes of the closure members on the opposite end surfaces.

During discharge in the metal-air battery 1 in FIG. 1, the negative electrode current collecting terminal and the positive electrode current collecting terminal are electrically connected to each other via, for example, a load such as lighting equipment. Zinc contained in the negative electrode 3 is oxidized into zinc ions, and electrons therein are supplied via the negative electrode current collecting terminal and the positive electrode current collecting terminal to the positive electrode 2. In the porous positive electrode 2, oxygen from the air, which has passed through the liquid-repellent layer 29, is reduced by the electrons supplied from the negative electrode 3 and dissolved as hydroxide ions in the electrolyte solution 40. That is, in the positive electrode 2, an oxygen reduction reaction of O₂+2H₂O+4e⁻→4OH⁻ occurs at the interfaces between the three phases of solid (catalyst), liquid (electrolyte solution), and gas (air). In the negative electrode 3, the reactions occur at the interfaces between the two phases of solid (electrode) and liquid (electrolyte solution) (the same applies the case during charge, which will be described later).

In the metal-air battery 1, oxygen from the air serving as an active material in oxygen reduction reactions can be easily diffused and supplied to the entire interface between the electrolyte solution 40 and the air during discharge by forming this interface inside the second catalyst layer 222 having a large average particle diameter and high gas diffusion properties. This improves the efficiency of the oxygen reduction reaction and reduces a concentration overvoltage caused by a reduction of oxygen concentration in the vicinity of the interface, thus improving discharge performance. Here, the concentration overvoltage is a voltage rise caused by rate-determining diffusion of the active material in each reaction, and may cause a reduction in the output of the battery. In the positive electrode 2, the oxygen reduction reaction during discharge occurs primarily in the second catalyst layer 222, and therefore, the second catalyst layer 222 may be regarded as a discharge reaction layer.

The second catalyst layer 222 is preferably formed of conductive ceramic that is superior in oxygen reduction reactions to the conductive ceramic of the first catalyst layer 221. The discharge performance of the metal-air battery 1 can be further improved by using a catalyst superior in oxygen reduction reaction for the second catalyst layer 222 that is in contact with both of the air and the electrolyte solution 40. A technique for evaluating the superiority of oxygen reduction reactions and oxygen generation reactions will be described later.

During charge in the metal-air battery 1, a voltage is applied between the negative electrode current collecting terminal and the positive electrode current collecting terminal, so that electrons are supplied from hydroxide ions to the positive electrode 2 and oxygen is generated. That is, in the positive electrode 2, an oxygen generation reaction of 4OH⁻→O₂+2H₂O+4e⁻ occurs at the interfaces between the two phases of solid (catalyst) and liquid (electrolyte solution). In the negative electrode 3, metal ions are reduced by the electrons supplied to the negative electrode current collecting terminal via the positive electrode current collecting terminal, and zinc is deposited.

At this time, electric field concentrations are less likely to occur because the coiled negative electrode 3 has no corners. That is, a large imbalance does not occur in the current density. In addition, the negative electrode 3 is uniformly in contact with the electrolyte solution 40. This considerably suppresses generation and growth of zinc dendrites deposited in dendritic form and whiskers deposited in whisker form (needle-like form). In actuality, the deposited metal layer is formed by uniformly depositing close-grained zinc on almost the entire surface of the negative electrode 3.

In the positive electrode 2, hydroxide ions serving as an active material in oxygen generation reactions can be easily supplied to the first catalyst layer 221 during charge by bringing the first catalyst layer 221 in almost its entirety, which has a small average particle diameter and a large total surface area, into contact with the electrolyte solution 40. This facilitates the oxygen generation reaction and reduces a concentration overvoltage caused by a reduction in hydroxide ion concentration, thus improving charge performance. In the positive electrode 2, the oxygen generation reaction during charge occurs primarily in the first catalyst layer 221, and therefore, the first catalyst layer 221 may be regarded as a charge reaction layer. An oxygen gas generated during charge is efficiently exhausted to the outside via the second catalyst layer 222 having a large average particle diameter.

The first catalyst layer 221 is preferably formed of conductive ceramic that is superior in oxygen generation reaction to the conductive ceramic of the second catalyst layer 222. The charge performance of the metal-air battery 1 can be further improved by using a catalyst superior in oxygen generation reaction for the first catalyst layer 221 that is in its entirety filled with the electrolyte solution 40 (or hydroxide ions contained in the electrolyte solution). Note that oxidation degradation caused by the oxygen generated during charge does not occur in the positive electrode 2 that does not contain a carbon material.

Here, the superiority of oxygen reduction reactions and oxygen generation reactions may be evaluated using, for example, a technique described in Japanese Patent Application Laid-Open No. 2005-190833 (Document 1 described above). More specifically, the technique involves forming gas-diffusion type electrodes that use various materials as their catalysts, causing oxygen reduction reactions and oxygen generation reactions to occur, and measuring its voltage with reference to a reference electrode that indicates a predetermined electrode current density. It can be said that the material with a higher voltage in oxygen reduction reaction is more superior in oxygen reduction reactions, and the material with a lower voltage in oxygen generation reaction is more superior in oxygen generation reactions.

Preferable materials for the first catalyst layer 221 and the second catalyst layer 222 are perovskite type oxides. Perovskite type oxides are expressed by ABO₃, where A is an alkali metal, an alkaline-earth metal, or a rare-earth metal, and B is a transition metal. A preferable material for the first catalyst layer 221 is configured such that the A-site in a perovskite type oxide consists of at least one of lanthanum (La) and strontium (Sr), and the B-site consists of at least one of Co and Fe. A preferable material for the second catalyst layer 222 is configured such that the A-site in a perovskite type oxide consists of at least one of La, Sr, and calcium (Ca), and the B-site consists of at least one of Fe, Ni, Co, and Mn. The material for the second catalyst layer 222 is preferably different from the material for the first catalyst layer 221. For example, when the second catalyst layer 222 serving as a discharge reaction layer is made of LSM or LSMF and the first catalyst layer 221 serving as a charge reaction layer is made of LSCF, the ceramic of the second catalyst layer 222 is superior in oxygen reduction reactions to the ceramic of the first catalyst layer 221, and the ceramic of the first catalyst layer 221 is superior in oxygen generation reactions to the ceramic of the second catalyst layer 222.

As described above, the porous positive electrode 2 in the metal-air battery 1 includes the positive electrode conductive layer 21, the first catalyst layer 221, and the second catalyst layer 222 in order from the negative electrode 3 to the air side, and the pores of the positive electrode conductive layer 21 and the first catalyst layer 221 are almost filled up with the electrolyte solution 40. The electrical resistance of the positive electrode conductive layer 21 can be reduced by making the positive electrode conductive layer 21 of conductive ceramic having a larger average particle diameter than the conductive ceramic of the first catalyst layer 221. Since the first catalyst layer 221 filled with the electrolyte solution 40 has a large total surface area, charge performance can be improved. Moreover, the second catalyst layer 222 disposed on the air side is made of conductive ceramic having a larger average particle diameter than the conductive ceramic of the first catalyst layer 221. This improves the gas diffusion properties of the second catalyst layer 222 and improves discharge performance. Accordingly, the battery performance of the metal-air battery 1 can be improved as described above.

The average particle diameter of ceramic particles of the second catalyst layer 222 is preferably larger than or equal to 1 μm in order to ensure a certain degree of gas diffusion properties in discharge, reactions, and is also preferably smaller than or equal to 10 μm in order to secure a certain degree of reaction area. With this second catalyst layer, the discharge performance of the metal-air battery 1 can be further improved. Moreover, the average particle diameter of conductive ceramic particles of the first catalyst layer 221 is preferably larger than or equal to 0.1 μm in order to secure pores in a range of sizes enough to hold the electrolyte solution, and is also preferably smaller than or equal to 2 μm in order to secure a certain amount of reaction area for charge reactions. With this first catalyst layer, the charge performance of the metal-air battery 1 can be further improved. When the particle diameter in the first catalyst layer 221 is excessively large, more strict limitations are imposed on the conditions for preserving the interface of the electrolyte solution 40 in the second catalyst layer 222. Thus, the average particle diameter of the first catalyst layer 221 is preferably smaller than or equal to 2 μm, from the viewpoint of easily suppressing leakage of the electrolyte solution 40 in the metal-air battery 1. Note that the average particle diameters of ceramic particles are determined by, for example, an intercept method using a scanning electron microscopy (SEM) image of a smooth surface obtained by grinding a cross-section of the positive electrode 2.

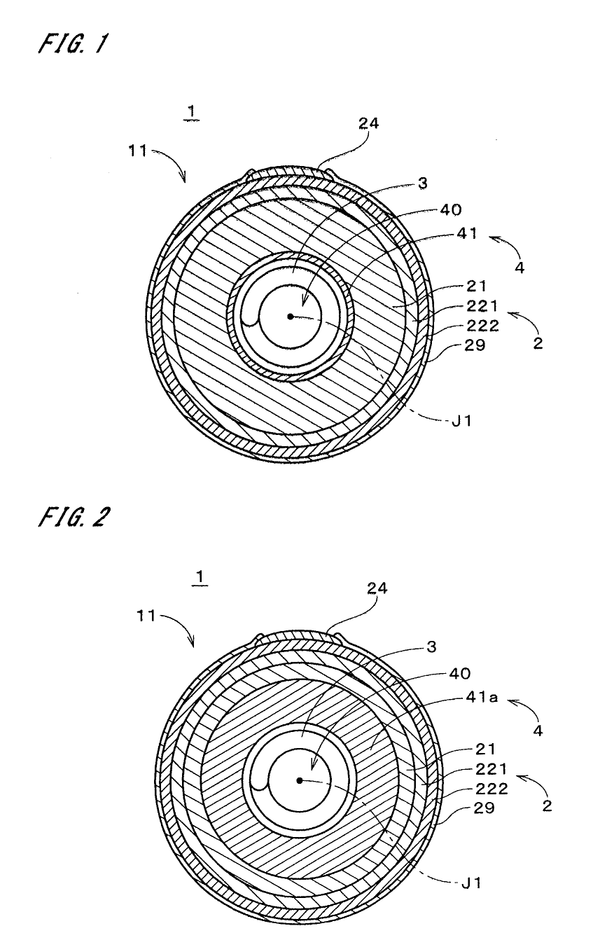

While the positive electrode conductive layer 21 serves as a supporter in the metal-air battery 1 in FIG. 1, other constituent elements may serve as a supporter. FIG. 2 illustrates another example of the metal-air battery 1. The metal-air battery 1 in FIG. 2 differs from the metal-air battery 1 in FIG. 1 in that a separator 41a serves as a supporter. The other configuration is similar to that of the metal-air battery 1 in FIG. 1, and identical constituent elements are given the same reference numerals.

The separator 41a serving as a supporter in the metal-air battery 1 in FIG. 2 is a porous sintered compact of ceramic having high insulating properties. Examples of the ceramic include alumina, zirconia, and hafnia. From the viewpoint of preparing the separator 41a at low cost, it is preferable to use alumina as the ceramic, and from the viewpoint of ensuring the strength and stability of the separator 41a, it is preferable to use zirconia.

The positive electrode 2 is formed on the outer side surface of the separator 41a that is part of the electrolyte layer 4. More specifically, the positive electrode conductive layer 21 responsible for electron conduction is circumferentially formed on the outer side surface of the separator 41a. Moreover, the first catalyst layer 221 is formed on the outer side surface of the positive electrode conductive layer 21, and the second catalyst layer 222 is formed on the outer side surface of the first catalyst layer 221. The positive electrode conductive layer 21, the first catalyst layer 221, and the second catalyst layer 222 are formed by, for example, depositing and firing predetermined slurry. The positive electrode 2 in FIG. 2 can ensure a certain degree of conductivity in the presence of the positive electrode conductive layer 21, the first catalyst layer 221, and the second catalyst layer 222.

Also in the metal-air battery 1 in FIG. 2 in which the separator 41a serves as a supporter, the first catalyst layer 221 is made of conductive ceramic having a smaller average particle diameter than the conductive ceramic of the positive electrode conductive layer 21. In this case, charge performance can be improved with the first catalyst layer 221 having a larger total surface area. Moreover, the second catalyst layer 222 is made of conductive ceramic having a larger average particle diameter than the conductive ceramic of the first catalyst layer 221. In this case, discharge performance can be improved with the second catalyst layer 222 having improved gas diffusion properties. As a result, the battery performance of the metal-air battery 1 can be improved.

### Examples

### Production of Porous Tube

First, LaSrMnO₃ (LSM) powder (manufactured by KCM Corporation Co., Ltd.) was pulverized into coarse particles by a cutter mill and then into small particles by a jet mill (manufactured by Nisshin Engineering INC.), and then classified by Turbo Classifier (manufactured by Nisshin Engineering INC.) to obtain LSM powder having an average particle diameter of 30 μm. Part of the powder was pulverized into fine particles by a ZrO₂ ball to obtain LSM powder having an average particle diameter of 0.5 μm. Then, 100 parts by mass of the LSM powder having an average particle diameter of 30 μm, 5 parts by mass of the LSM powder (sintering agent) having an average particle diameter of 0.5 μm, 12 parts by mass of ion-exchanged water, 12 parts by mass of a binder (manufactured by YUKEN Industry Co., Ltd.), and 4 parts by mass of glycerin were weighed and combined into a mixture, and the mixture was subjected to extrusion molding to obtain a cylindrical tube having an outer diameter of 17.0 mm and an inner diameter of 12.8 mm. This cylindrical tube was fired at 1450° C. for five hours in an ambient atmosphere and then cut to a length of 70 mm. In this way, a porous cylindrical tube serving both as a conductive layer and a supporter was obtained.

### Preparation of Slurry for Separator

First, 75 parts by mass of SOLMIX (registered trademark) H-37 (manufactured by Japan Alcohol Trading Co., Ltd.), 25 parts by mass of 2-(2-n-butoxyethoxy)ethyl acetate (manufactured by Kanto Chemical Co., INC.), and 3.4 parts by mass of ethyl cellulose (manufactured by Tokyo Chemical Industry Co., Ltd.) were weighed, combined, and stirred for one hour. Then, 32 parts by mass of alumina (e.g., A-43-M manufactured by SHOWA DENKO K.K.) was weighed, put in a pot mill with a resin ball having a diameter of 10 mm and the mixture obtained by the stirring, and combined for 50 hours using a ball mill. In this way, the slurry for the separator was obtained.

### Formation of Separator

A hose-like cap (playing a role of a funnel) was placed in the upper opening of the above porous tube, and a sealing stopper was placed in the lower opening. The hose-like cap in the upper opening prevents the overflow of slurry. By using the funnel, the slurry for the separator was injected from the upper opening into the porous tube covered with the hose-like cap. The porous tube was held for one minute while filled up with the slurry. Thereafter, the sealing stopper in the lower opening was removed to discharge the slurry. The porous tube was dried at ambient temperature for 15 hours or more and then dried at 50° C. for two hours or more. The porous tube was then placed upside down, and the aforementioned operations were repeated once again. Thereafter, the porous tube was fired at 1150° C. for four hours to form a separator on the inner side surface of the porous tube.

### Preparation of Slurry for Catalyst Layers

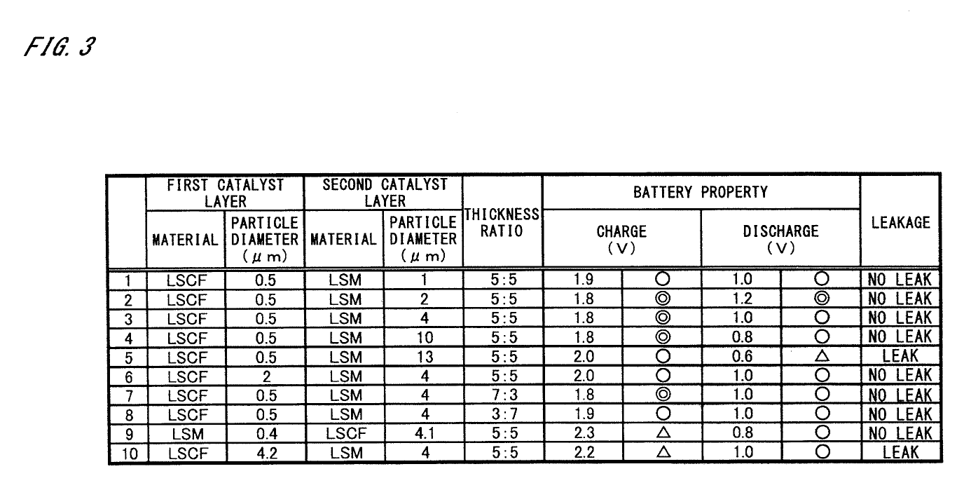

First, LSM powder and LaSrCoFeO₃ (LSCF) powder (manufactured by KCM Corporation Co., Ltd.) were pulverized into coarse particles by a cutter mill and then into fine particles by a jet mill, and then classified by Turbo Classifier to obtain LSM powder and LSCF powder having various particle diameters. On the other hand, 75 parts by mass of SOLMIX H-37, 25 parts by mass of 2-(2-n-butoxyethoxy)ethyl acetate, and 5 parts by mass of ethyl cellulose were weighed, combined, and stirred for one hour. Then, 65 parts by mass of the LSCF powder obtained by the classification and having a fixed particle diameter were weighed, put in a pot mill with a resin ball having a diameter of 10 mm, and combined for 50 hours using a ball mill. In this way, the slurry for the first catalyst layer (in the case of the ninth sample in FIG. 3, which will be described later, the slurry for the second catalyst layer) was obtained. Similarly to the slurry for the first catalyst layer, the slurry for the second catalyst layer (in the case of the ninth sample, which will be described later, the slurry for the first catalyst layer) were obtained using the LSM powder obtained by the classification and having a fixed particle diameter.

### Formation of Catalyst Layers

The slurry for the first catalyst layer was injected into a graduated cylinder, and the porous tube was inserted (dipped) into the graduated cylinder and held for one minute while the upper and lower openings of the porous tube provided with the separator were sealed with silicon rubber. The porous tube was then taken out of the graduated cylinder, air-dried for 30 minutes, and dried at 80° C. for one and a half hours. Next, the slurry for the second catalyst layer was injected into a graduated cylinder, and the above porous tube was inserted into the graduated cylinder and held for one minute. The porous tube was then taken out of the graduated cylinder, air-dried for 30 minutes, and dried at 80° C. for one and a half hours. Thereafter, the porous tube was fired at 1150° C. for five hours in an ambient atmosphere. In this way, the porous tube having the first and second catalyst layers on the outer side surface was obtained.

### Preparation of Slurry for Interconnector

First, 75 parts by mass of SOLMIX H-37, 25 parts by mass of 2-(2-n-butoxyethoxy)ethyl acetate, and 5 parts by mass of ethyl cellulose were weighed, combined, and stirred for one hour. Then, 40 parts by mass of LSCF powder obtained by the classification and having an average particle diameter of 0.4 μm were weighed, put in a pot mill with a resin ball having a diameter of 10 mm and the mixture obtained by the stirring, and combined for 50 hours using a ball mill. In this way, the slurry for the interconnector was obtained.

### Formation of Interconnector

Two areas of the outer side surface of the above porous tube that were spaced from each other at an interval of 180 degrees in the circumferential direction were set, and the area other than the two areas was masked. The slurry for the interconnector was injected into a graduated cylinder, and the porous tube was inserted (dipped) into the graduated cylinder and held for one minute while the upper and lower openings of the porous tube were sealed with silicon rubber. The porous tube was then taken out of the graduated cylinder, air-dried for 30 minutes, and dried at 80° C. for one and a half hours. The above operations (slurry coating and drying) were repeated five times. Thereafter, the porous tube was fired at 1150° C. for four hours in an ambient atmosphere. In this way, the interconnector was formed on the porous tube.

### Preparation of Dispersion for Liquid Repellent Layer

First, undiluted FEP dispersion (manufactured by Du Pont-Mitsui Fluorochemicals Co., Ltd.) was diluted to 20 wt %, and small amounts of ALKOX (registered trademark) E-30 (manufactured by MEISEI Corporation), which serves as a thickener, were added to the diluted FEP solution while stirring the solution (in order to not form a cluster of the thickener), so that the diluted FEP solution contained 2.5 wt % ALKOX.

### Formation of Liquid Repellent Layer

The interconnector portion of the porous tube was covered with a tape so that a portion of the liquid repellent layer that overlapped with the interconnector had a width of 1 mm, and the porous tube was immersed in the aforementioned dispersion for one minute. The porous tube was then dried at ambient temperature for 30 minutes and at 60° C. for 15 hours, and further fired at 280° C. for fifty minutes in an ambient atmosphere. In this way, the porous tube having the liquid repellent layer in a portion that is in the vicinity of the outer side surface of the second catalyst was obtained.

### Evaluation of Battery Performance

FIG. 3 illustrates the materials and particle diameters (average particle diameters) of the first and second catalyst layers for each positive electrode sample produced as described above. As described previously, the first catalyst layer is formed on the outer side surface of the porous tube, which serves as a conductive layer, and the second catalyst layer is formed on the outer side surface of the first catalyst layer. In FIG. 3, the “Thickness Ratio” field indicates the ratio (T1:T2) between the thickness T1 of the first catalyst layer and the thickness T2 of the second catalyst layer.

A Cu coil having 2 g of zinc electrodeposited thereon was inserted as a negative electrode inside each positive electrode sample, an electrolyte solution (containing 7 molar (M) KOH and 0.65 M zinc oxide (ZnO)) was circulated through the sample, and charge and discharge properties of the battery were measured at ambient temperature. In FIG. 3, the “Charge” and “Discharge” fields in the “Battery Property” field indicate voltages for the case where the current density in the metal-air battery using each positive electrode sample is at 10 mA/cm². The “Charge” field was marked with a double circle when the voltage is less than or equal to 1.8V, marked with a single circle when the voltage is higher than 1.8V and less than or equal to 2.0V, and marked with a triangle when the voltage is higher than 2.0V. The “Discharge” field was marked with a double circle when the voltage is higher than or equal to 1.2V, marked with a single circle when the voltage is less than 1.2V and higher than or equal to 0. 8V, and marked with a triangle when the voltage is less than 0.8V. Moreover, the surface of each positive electrode sample was observed at the time of measurement to confirm the presence or absence of leakage. The “Leakage” field indicates the result of confirmation.

In the tenth sample in FIG. 3, the average particle diameter of particles of the first catalyst layer was larger than that of the second catalyst layer, leakage occurred, and charge performance showed degradation. In the first to eighth samples, on the other hand, the average particle diameter of the first catalyst layer was smaller than that of the second catalyst layer, and desirable charge performance was achieved. In the fifth sample, degradation in the discharge performance was considered due to leakage caused by large particle diameters in the second catalyst layer, but it was expected that the discharge performance could be improved by optimizing the formation of the liquid repellent layer. A comparison between the third sample and the ninth sample showed that LSM is superior in oxygen reduction reactions to LSCF, and LSCF is superior in oxygen generation reactions to LSM.

The first catalyst layer needs pores for holding the electrolyte solution and preferably has an average particle diameter larger than or equal to 0.1 μm, more preferably larger than or equal to 0.2 μm, from the viewpoint of securing pores in a certain range of sizes. It can be said from the results of the charge performance of the third, sixth, and tenth samples that the charge performance of the metal-air battery improves when the first catalyst layer has an average particle diameter of 2 μm or less. Since the charge performance improves as the average particle diameter of particles decreases, i.e., the effective reaction area (total surface area) increases, it can be said from the above results that the average particle diameter of particles is more preferably smaller than or equal to 0.8 μm.

It can also be said from the results of the discharge performance and the presence or absence of leakage of the first to fifth samples that the discharge performance can be improved while suppressing leakage when the second catalyst layer has an average particle diameter larger than or equal to 1 μm and smaller than or equal to 10 μm. From the viewpoint of further improving the gas diffusion properties of the second catalyst layer, the average particle diameter of the second catalyst layer is preferably larger than or equal to 2 μm. On the other hand, the discharge performance degrades in the second catalyst layer as the effective reaction area decreases. Thus, from the viewpoint of ensuring higher discharge performance, the average particle diameter of the second catalyst layer is preferably smaller than or equal to 6 μm (more preferably, smaller than or equal to 4 μm) to increase the effective reaction area.

More desirable charge and discharge performance can be achieved when the value of a ratio D2/D1 is higher than or equal to 2 and lower than or equal to 20, where D1 is the average particle diameter of the first catalyst layer and D2 is the average particle diameter of the second catalyst layer. The results of the charge and discharge performance of the third, seventh, and eighth samples show that desirable charge and discharge performance can be more reliably preserved when the thickness ratio is 3:7, 5:5, or 7:3. Accordingly, the second catalyst layer preferably has a thickness that is greater than or equal to 0.4 times the thickness of the first catalyst layer (which corresponds to a thickness ratio of 7:3) and less than or equal to 2.3 times the thickness of the first catalyst layer (which corresponds to a thickness ratio of 3:7). In this case, it is also possible to easily ensure high liquid repellent properties.

The metal-air battery 1 described above may be modified in various forms.

The metal-air battery 1 may include a negative electrode 3 provided around a tubular positive electrode 2. That is, the negative electrode 3 may oppose either the inner side surface or outer side surface of the positive electrode 2. In either case, the first catalyst layer 221 is formed on the surface of the positive electrode conductive layer 21 on the side opposite to the negative electrode 3, and the second catalyst layer 222 is formed on the surface of the first catalyst layer 221 on the side opposite to the negative electrode 3. The shape of the metal-air battery 1 may be other than a cylindrical shape, and the shapes of the positive electrode 2, the negative electrode 3, and the electrolyte layer 4 may also be appropriately changed.

The configurations of the above-described preferred embodiments and variations may be appropriately combined as long as there are no mutual inconsistencies.

While the invention has been shown and described in detail, the foregoing description is in all aspects illustrative and not restrictive. It is therefore to be understood that numerous modifications and variations can be devised without departing from the scope of the invention. This application claims priority benefit under 35 U.S.C. Section 119 of Japanese Patent Application No. 2016-098923 filed in the Japan Patent Office on May 17, 2016, the entire disclosure of which is incorporated herein by reference.

### REFERENCE SIGNS LIST

1 Metal-air battery
2 Positive electrode
3 Negative electrode
4 Electrolyte layer
21 Positive electrode conductive layer
40 Electrolyte solution
221 First catalyst layer
222 Second catalyst layer

1. A metal-air secondary battery comprising:
a positive electrode;
a negative electrode opposing said positive electrode; and
an electrolyte layer disposed between said positive electrode and said negative electrode and containing an electrolyte solution,
wherein said positive electrode includes:
a positive electrode conductive layer that is a porous layer made of conductive ceramic and has pores filled with said electrolyte solution;
a first catalyst layer that is a porous layer formed on a surface of said positive electrode conductive layer on a side opposite to said negative electrode, is made of conductive ceramic having a smaller average particle diameter than the conductive ceramic of said positive electrode conductive layer, and has pores filled with said electrolyte solution; and
a second catalyst layer that is a porous layer formed on a surface of said first catalyst layer on the side opposite to said negative electrode and is made of conductive ceramic having a larger average particle diameter than the conductive ceramic of said first catalyst layer.

2. The metal-air secondary battery according to claim 1, wherein
said second catalyst layer holds particles of a liquid repellent material in a portion that is in the vicinity of a surface of said second catalyst layer on the side opposite to said negative electrode.

3. The metal-air secondary battery according to claim 1, wherein
the average particle diameter of the conductive ceramic of said first catalyst layer is larger than or equal to 0.1 micrometers and smaller than or equal to 2 micrometers.

4. The metal-air secondary battery according to claim 1, wherein
the average particle diameter of the conductive ceramic of said second catalyst layer is larger than or equal to 1 micrometer and smaller than or equal to 10 micrometers.

5. The metal-air secondary battery according to claim 1, wherein
said second catalyst layer has a thickness that is greater than or equal to 0.4 times a thickness of said first catalyst layer and less than or equal to 2.3 times the thickness of said first catalyst layer.

6. The metal-air secondary battery according to claim 1, wherein
the conductive ceramic of said first catalyst layer and the conductive ceramic of said second catalyst layer are different materials.

7. The metal-air secondary battery according to claim 6, wherein
the conductive ceramic of said first catalyst layer is superior in oxygen generation reaction to the conductive ceramic of said second catalyst layer, and
the conductive ceramic of said second catalyst layer is superior in oxygen reduction reaction to the conductive ceramic of said first catalyst layer.

8. The metal-air secondary battery according to claim 2, wherein
the conductive ceramic of said first catalyst layer and the conductive ceramic of said second catalyst layer are different materials.

9. The metal-air secondary battery according to claim 8, wherein
the conductive ceramic of said first catalyst layer is superior in oxygen generation reaction to the conductive ceramic of said second catalyst layer, and
the conductive ceramic of said second catalyst layer is superior in oxygen reduction reaction to the conductive ceramic of said first catalyst layer.

10. The metal-air secondary battery according to claim 3, wherein
the conductive ceramic of said first catalyst layer and the conductive ceramic of said second catalyst layer are different materials.

11. The metal-air secondary battery according to claim 10, wherein
the conductive ceramic of said first catalyst layer is superior in oxygen generation reaction to the conductive ceramic of said second catalyst layer, and
the conductive ceramic of said second catalyst layer is superior in oxygen reduction reaction to the conductive ceramic of said first catalyst layer.

12. The metal-air secondary battery according to claim 4, wherein
the conductive ceramic of said first catalyst layer and the conductive ceramic of said second catalyst layer are different materials.

13. The metal-air secondary battery according to claim 12, wherein
the conductive ceramic of said first catalyst layer is superior in oxygen generation reaction to the conductive ceramic of said second catalyst layer, and
the conductive ceramic of said second catalyst layer is superior in oxygen reduction reaction to the conductive ceramic of said first catalyst layer.

14. The metal-air secondary battery according to claim 5, wherein
the conductive ceramic of said first catalyst layer and the conductive ceramic of said second catalyst layer are different materials.

15. The metal-air secondary battery according to claim 14, wherein
the conductive ceramic of said first catalyst layer is superior in oxygen generation reaction to the conductive ceramic of said second catalyst layer, and
the conductive ceramic of said second catalyst layer is superior in oxygen reduction reaction to the conductive ceramic of said first catalyst layer.
